(19) United States
(12) Patent Application Publication
(10) Pub. No.: US 2006/0288849 A1
(43) Pub. Date: Dec. 28, 2006

(54) Method for processing an audio sequence for example a piece of music

(76) Inventor: Geoffroy Peeters, Paris (FR)

Correspondence Address: HOLLAND & KNIGHT LLP, 10 ST. JAMES AVENUE, BOSTON, MA, 02116, US

(21) Appl. No.: 10/562,242

(22) PCT Filed: Jun. 16, 2004
(86) PCT No.: PCT/FR04/01493

§ 371 Date: Dec. 22, 2005

(30) Foreign Application Priority Data
Jun. 25, 2003 (FR) 03/07667

(51) Int. Cl. G10H 7/00

(52) U.S. Cl. 84/616

(57) ABSTRACT

A method of processing a sound sequence corresponding in particular to a piece of music includes a succession of subsequences from among at least an introduction, a verse, a refrain, a bridgeway, a theme, a motif, a movement, in which: a) a spectral transform is applied to said sequence to obtain spectral coefficients varying as a function of time in said sequence, b) at least one subsequence repeated in said sequence is determined by statistical analysis of said spectral coefficients, and c) start and end instants of a first subsequence, such as a verse, and of a second subsequence, such as a refrain, are evaluated so as to substantially concatenate the first subsequence with the second subsequence.

The present invention relates to the processing of a sound sequence, such as a piece of music or, more generally, a sound sequence comprising the repetition of a subsequence.

Distributors of musical productions, for example recorded on CD, cassette or other medium, make booths available to potential customers where the customers can listen to music of their choice, or else music promoted on account of its novelty. When a customer recognizes a verse or a refrain from the piece of music to which he is listening, he can decide to purchase the corresponding musical production.

More generally, an averagely attentive listener concentrates his attention more on a verse and refrain strung together, than on the introduction of the piece, in particular. It will thus be understood that a sound resume comprising at least one verse and one refrain would suffice for dissemination among booths of the aforesaid type, rather than providing for the complete musical production to be disseminated.

In another application such as the transmission of sound data by mobile telephone, it will be understood that the downloading of the complete piece of music onto a mobile terminal, from a remote server, is much lengthier and, therefore, more expensive than the downloading of a sound resume of the aforesaid type.

Likewise, in an electronic commerce context, sound resumes may be downloaded onto a facility communicating with a remote server, via an extended network of the INTERNET type. The user of the computer facility may thus place an order for a musical production whose sound resume he likes.

However, detecting a verse and a refrain by ear and thus creating a sound resume for all the musical productions distributed would be a prohibitively cumbersome task.

The present invention aims to improve the situation.

One of the aims of the present invention is to propose an automated detection of a subsequence repeated in a sound sequence.

Another aim of the present invention is to propose an automated creation of sound resumes of the type described above.

For this purpose, the present invention pertains firstly to a method of processing a sound sequence, in which:

a) a spectral transform is applied to said sequence to obtain spectral coefficients varying as a function of time in said sequence.

The method within the sense of the invention furthermore comprises the following steps:

b) at least one subsequence repeated in said sequence is determined by statistical analysis of said spectral coefficients, and

c) start and end instants of said subsequence in the sound sequence are evaluated.

Advantageously, according to an additional step:

d) the aforesaid subsequence is extracted so as to store, in a memory, sound samples representing said subsequence.

Preferably, the extraction of step d) relates to at least one subsequence whose duration is the biggest and/or one subsequence whose frequency of repetition is the biggest in said sequence.

The present invention finds an advantageous application in aiding the detection of failures of industrial machines or motors, especially by obtaining sound recording sequences of phases of acceleration and of deceleration of the motor speed. The application of the method within the sense of the invention makes it possible to isolate a sound subsequence corresponding for example to a steady speed or to an acceleration phase, this subsequence being, as the case may be, compared with a reference subsequence.

In another advantageous application to the obtaining of musical data of the type described above, the sound sequence is a piece of music comprising a succession of subsequences from among at least an introduction, a verse, a refrain, a bridgeway, a theme, a motif, or a movement which is repeated in the sequence. In step c), at least the respective start and end instants of a first subsequence and of a second subsequence are determined.

In a particularly advantageous embodiment, in step d), a first and a second subsequence are extracted so as to obtain, on a memory medium, a sound resume of said piece of music comprising at least the first subsequence strung together with the second subsequence.

Preferably, the first subsequence corresponds to a verse and the second subsequence corresponds to a refrain.

However, it may happen that a first and a second subsequence, that are extracted from a sound sequence, are not contiguous in time.

For this purpose, the following steps are moreover provided:

d1) detecting at least one cadence of the first subsequence and/or of the second subsequence so as to estimate the mean duration of a bar at said cadence, as well as at least one end segment of the first subsequence and at least one start segment of the second subsequence, of respective durations corresponding substantially to said mean duration and isolated in the sequence by an integer number of mean durations,

d2) generating at least one bar of transition of duration corresponding to said mean duration and comprising an addition of the sound samples of at least said end segment and of at least said start segment,

d3) and concatenating the first subsequence, the transition bar or bars and the second subsequence to obtain a stringing together of the first and of the second subsequence.

It will be noted that the succession of steps d1) to d3) finds, over and above the automatic generation of sound resumes, an advantageous application to computer assisted musical creation. In this application, a user can himself create two subsequences of a piece of music, whereas software comprising instructions for running steps d1) to d3) provides for the stringing together of the two subsequences by concatenation, without artefact and pleasant to the ear.

More generally, the present invention is also aimed at a computer program product, stored in a computer memory or on a removable medium able to cooperate with a computer reader, and comprising instructions for running the steps of the method within the sense of the invention.

Other characteristics and advantages of the invention will become apparent on examining the detailed description hereinbelow, and the appended drawings in which:

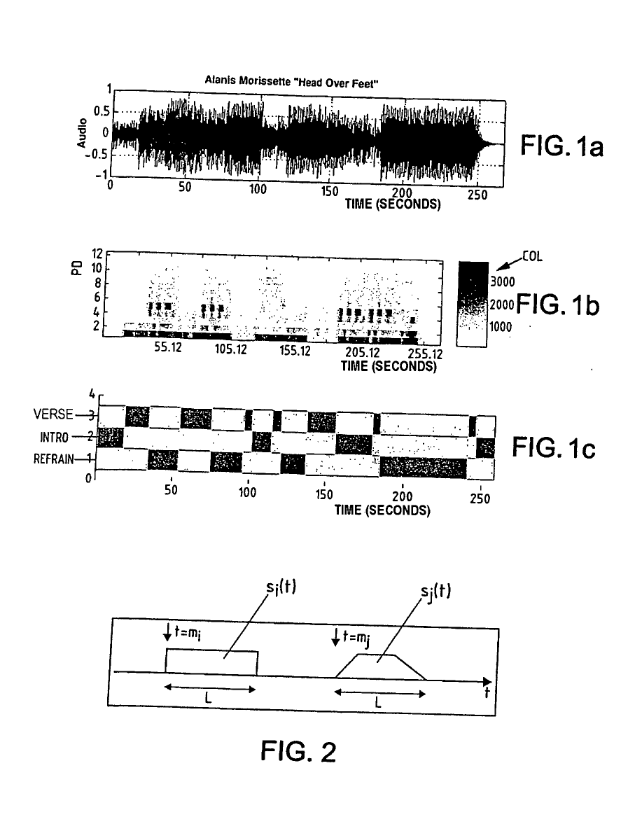

FIG. 1a represents an audio signal of a piece of music corresponding, in the example represented, to a light popular song;

FIG. 1b represents the variation in spectral energy as a function of time, for the piece of music whose audio signal is represented in FIG. 1a;

FIG. 1c illustrates the durations occupied by the various passages of the piece of music of FIG. 1a and which repeat in this piece;

FIG. 2 diagrammatically represents time windows selected from two respective parts of the piece of music so as to prepare the concatenation of these two parts, according to the succession of steps d1) to d3) hereinabove;

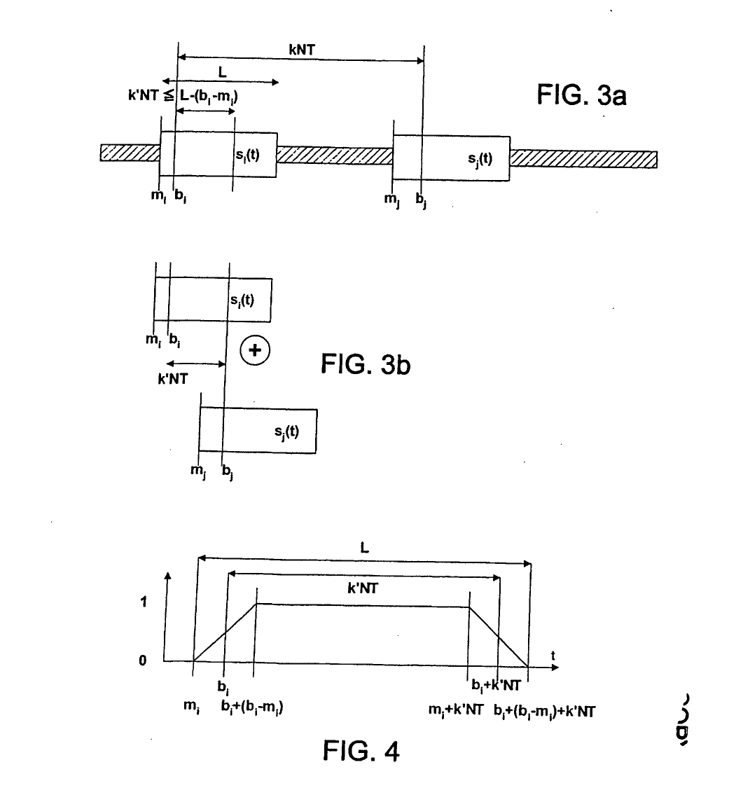

FIG. 3a diagrammatically represents segments sᵢ(t) and sⱼ(t) selected from the aforesaid respective parts of the piece, so as to prepare a concatenation of the two parts by superposition/addition;

FIG. 3b diagrammatically illustrates by the sign “⊕” the aforesaid superposition/addition;

FIG. 4 illustrates a time window for the aforesaid concatenation, of preferred shape and preferred width; and

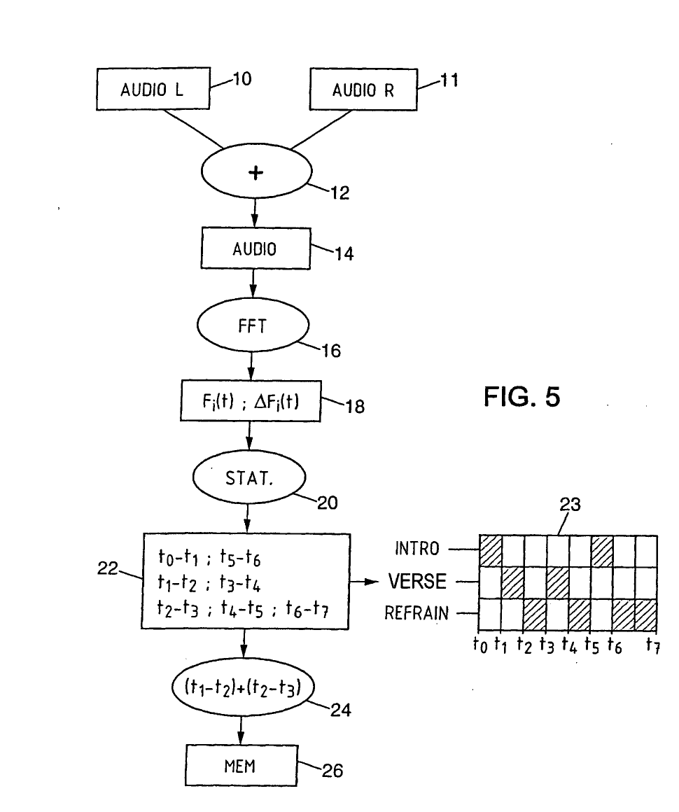

FIG. 5 represents a flowchart for processing a sound sequence, in a preferred embodiment of the present invention.

The audio signal of FIG. 1a represents the sound intensity (ordinate) as a function of time (abscissa) of a piece of music (here, the piece “head over feet”© by the artiste Alanis Morissette). To construct this audio signal, the respective signals of the right and left channels (in stereophonic mode) have been synchronized and added together.

To the audio signal represented in FIG. 1a is applied a spectral transform (for example of FFT fast Fourier transform type) to obtain a temporal variation of the spectral energy of the type represented in FIG. 1b.

In an embodiment, one is concerned with a plurality of successive short-term FFTs, the result of which is applied to a bank of filters over several ranges of frequencies (preferably of wavelengths that increase like the logarithm of the frequency). Another Fourier transform is then applied to obtain dynamic parameters of the audio signal (which are referenced PD in FIG. 1b). In particular, the ordinate scale of FIG. 1b indicates the amplitude of the variations of the components at various rates in a given frequency domain. Thus, the index 0 or 2 of the arbitrary ordinate scale of FIG. 1b corresponds to a slow variation in the low frequencies, while the index 12 of this same scale corresponds to a fast variation in the high frequencies. These variations are expressed as a function of time, along the abscissa (seconds). The intensities associated with these dynamic parameters PD, over time, are illustrated by various gray levels whose relative values are indicated by the reference column COL (on the right in FIG. 1b).

It is indicated that the dynamic parameters of the type represented in FIG. 1b make it possible to identify a piece of music completely. In this context of “imprint” of a piece of music, patent application FR-2834363 from the applicant describes in a detailed manner these parameters and the way of obtaining them.

As a variant, the variables deduced from the audio signal and making it possible to characterize the piece of music may be of different type, in particular so-called “Mel Frequency Cepstral Coefficients”. Globally, it is indicated that these coefficients (known per se) are still obtained by a short-term fast Fourier transform.

FIG. 1c offers a visual representation of the profile of the spectral energy of FIG. 1b. In FIG. 1c, the abscissa represents time (in seconds) and the ordinates represent the various parts of the piece, such as the verses, the refrains, the introduction, a theme, or the like. The repetition over time of a similar part, such as a verse or a refrain, is represented by hatched rectangles which appear at various abscissae over time (and which may be of different temporal widths), but of like ordinates. To go from the representation of FIG. 1b to the representation of FIG. 1c, a statistical analysis is implemented using for example the “K-means” algorithm, or else the “FUZZY K-means” algorithm, or else a hidden Markov chain, with learning by the BAUM-WELSH algorithm, followed by an evaluation by the VITERBI algorithm.

Typically, the determination of the number of states (the parts of the piece of music) which are necessary for the representation of a piece of music is performed in an automated manner, by comparison of the similarity of the states found at each iteration of the aforesaid algorithms, and by eliminating the redundant states. This technique, termed “pruning” thus makes it possible to isolate each redundant part of the piece of music and to determine its temporal coordinates (its start and end instants, as indicated hereinabove).

Thus, one studies the variations, for example in the tonal frequencies (of a human voice), of the spectral energy to determine the repetition of a particular musical passage in the audio signal.

Preferably, one seeks to extract one or more musical passages whose duration is the biggest in the piece of music and/or whose frequency of repetition is the biggest.

For example, for most light popular pieces, it will be possible to choose to isolate the refrain parts, whose repetition is generally the most frequent, and then the verse parts, whose repetition is frequent, then, as the case may be, other parts again if they repeat.

It is indicated that other types of subsequences representative of the piece of music may be extracted, provided that these subsequences repeat in the piece of music. For example, it is possible to choose to extract a musical motif, generally of shorter duration than a verse or a refrain, such as a passage of percussion repeated in the piece of music, or else a vocal phrase chanted several times in the piece. Furthermore, a theme may also be extracted from the piece of music, for example a musical phrase repeated in a piece of jazz or of classical music. In classical music, a passage such as a movement may moreover be extracted.

In the visual resume represented by way of example in FIG. 1c, the hatched rectangles indicate the presence of a part of the piece such as the introduction (“intro”), of a verse or of a refrain in a time window indicated by the temporal abscissa (in seconds). Thus, between 0 and around 15 seconds, the piece of music begins with an introduction (indexed by the digit 2 on the ordinate scale). The introduction is followed by two alternations of a verse (indexed by the digit 3) and of a refrain (indexed by the digit 1) up to around 100 seconds.

Reference is now made to FIG. 5 to describe the main steps of the method for obtaining the aforesaid sound resume, according to a preferred embodiment. Firstly, the audio signals are obtained on the left channel “audio L” and on the right channel “audio R” in the respective steps 10 and 11, when the initial sound sequence is represented in stereophonic mode. The signals of these two channels are added together in step 12 to obtain an audio signal of the type represented in FIG. 1a. This audio signal is, as the case may be, stored in sampled form in a work memory with sound intensity values ranked as a function of their associated temporal coordinates (step 14). To these audio data are applied a spectral transform (of FFT type in the example represented), in step 16, to obtain, in step 18, the spectral coefficients Fᵢ(t) and/or their variation ΔFᵢ(t) as a function of time. In step 20, a statistical analysis module operates on the basis of the coefficients obtained in step 18 to isolate instants t₀, t₁, . . . , t₇ which correspond to start and end instants of the various subsequences which repeat in the audio signal of step 14.

In the example represented, the piece of music exhibits a structure (classical in light popular) of the type comprising:
an introduction in the start of the piece between an instant to and an instant t₁,
a verse between t₁ and t₂,
a refrain between t₂ and t₃,
a second verse between t₃ and t₄,
a second refrain between t₄ and t₅,
an introduction, again, as the case may be supplemented with an instrumental solo, between the instants t₅ and t₆, and
the repetition of two end-of-piece refrains between the instants t₆ and t₇.

In step 22, the instants t₀ to t₇ are catalogued and indexed as a function of the corresponding musical passage (introduction, verse or refrain) and stored, as the case may be, in a work memory. In step 23, it is then possible to construct a visual resume of this piece of music, as represented in FIG. 5.

In the example described hereinabove of a light popular piece comprising a typical structure, the sound resume is constructed from a verse extracted from the piece, followed by a refrain extracted from the piece. In step 24, a concatenation is prepared of the sound samples of the audio signal between the instants t₁ and t₂, on the one hand, and between the instants t₂ and t₃, on the other hand, in the example described. As the case may be, the result of this concatenation is stored in a permanent memory MEM for subsequent use, in step 26.

However, as a general rule, the end instant of an isolated verse and the start instant of an isolated refrain are not necessarily identical, or else, one may choose to construct the sound resume from the first verse and the second refrain (between t₄ and t₅) or from the end refrain (between t₆ and t₇). Thus, the two passages selected to construct the sound resume are not necessarily contiguous.

A blind concatenation of sound signals corresponding to two parts of a piece of music gives an impression unpleasant to the ear. Hereinbelow is described, with reference to FIGS. 2, 3a, 3b and 4, the construction of a sound signal by concatenation of two parts of a piece of music, in such a way as to overcome this problem.

One of the aims of this construction by concatenation is to locally preserve the tempo of the sound signal.

Another aim is to ensure a temporal distance between points of concatenation (or points of “alignment”) that is equal to an integer multiple of the duration of a bar.

Preferably, this concatenation is performed by superposition/addition of sound segments chosen and isolated from the two abovementioned respective parts of the piece of music.

Described below is a superposition/addition of such sound segments, firstly by beat synchronization (termed “beat-synchronous”), then by bar synchronization according to a preferred embodiment.

The following notation applies:

bpm, the number of beats per minute of a piece of music,
D, the reference of this number bpm (for example in the case of a piece denoted “120=crotchet”, bpm=120 and D=crotchet),
T, the duration (expressed in seconds) of a beat, that is to say of the reference D: in the above example where D=crotchet, we have

$$T = \frac{60}{bpm}$$
N, the numerator of the metric of the piece of music (for example, in the case of a bar denoted “¾, N=3),
M, the duration (expressed in seconds) of a bar, given by the relation M=N.T (i.e. M=3*60/120 in the above example),
s(t), the audio signal of a piece of music,
ŝ(t), the signal reconstructed by superposition/addition, and
sᵢ(t) and sⱼ(t), the i^{th} and j^{th} segments which comprise respective audio signals belonging to a first and to a second passage of a piece of music, and which are used for the construction of ŝ(t) by superposition/addition.

In principle, the aforesaid first and second passages are not contiguous. ŝ(t) is then obtained as follows.

Referring to FIG. 2, the segments sᵢ(t) and sⱼ(t) are firstly formed by splitting the audio signal with the aid of a time window h_{L}(t), of width L and defined (of non zero value) between 0 and L. This window may be of rectangular type, of so-called “Hanning” type, of so-called “staircase Hanning” type, or the like. Referring to FIG. 4, a preferred type of time window is obtained by concatenation of a rising flank, of a plateau and of a falling flank. The preferred temporal width of this window is indicated hereinbelow.

The first segment sᵢ(t) is then defined so that:
sᵢ(t)=s(t+mᵢ).h_{L}(t) [1]
where mᵢ is the start instant of the first segment.

As shown by FIG. 3a, sⱼ(t) is constructed in substantially the same way:
sⱼ(t)=s(t+mⱼ).h_{L}(t) [1a]
where mⱼ is the start instant of the second segment.

Even if the duration L of the time window is the same for both segments, it is however indicated that the shape of the window may be different from one segment sᵢ(t) to the other sⱼ(t), as shown moreover by FIG. 2.

Let bᵢ and bⱼ be two respective positions inside the first and second segments, and called the “synchronization positions”, with respect to which the superposition/addition is performed, and such that:
0≦bᵢ≦L and 0≦bⱼ≦L [2]

Advantageously, the temporal distance between bᵢ and bⱼ is chosen equal to an integer multiple of the duration T of a beat (bⱼ−bᵢ=kT). Under these conditions, there is said to be a “beat-synchronous” reconstruction if

$$\begin{matrix}\hat{s} ( t ) = {\sum }_{i} {s}_{i}^{′} ( t - ( i - 1 ) \cdot ( {k}^{′} T ) + c ) \\ with & [ 4 ] \\ {s}_{i}^{′} ( t ) = {s}_{i} ( t + {b}_{i} ) & [ 5 ]\end{matrix}$$

and where k′ is the largest integer such that k′T≦L−(bᵢ−mᵢ), c is a time constant such that c=bᵢ−mᵢ.

Advantageously, the distance between the instants mᵢ and mⱼ is chosen equal to an integer multiple of k′NT, in which N denotes the numerator of the metric.

Thus, the reconstructed signal may be written:

$$\hat{s} ( t ) = {\sum }_{i} {s}_{i}^{′} ( t - ( i - 1 ) \cdot ( {k}^{′} NT ) + c )$$

An in-time synchronous superposition/addition is then obtained. FIG. 3b illustrates this situation. FIG. 4 shows that the width L of the aforesaid time window is approximately k′NT (to within the rising and falling flanks). However, ramps of flanks such that k′T≦L−2(bᵢ−mᵢ) will preferably be chosen in this case.

More particularly, the instants mᵢ and mⱼ are chosen so that they correspond to a first bar time. Under these conditions, a so-called “aligned” beat-synchronous superposition/addition is advantageously obtained.

Thus, by moreover determining the metric of the first passage and/or of the second passage, an in-time beat-synchronous reconstruction can be performed. If, moreover, the first and second segments are chosen so that they commence with a first bar time, this beat-synchronous reconstruction is aligned.

It is indicated that a reconstruction of the signal ŝ (t) may be undertaken on the basis of more than two musical passages to be concatenated. For i musical passages (i>2), the generalization of the above method is expressed by the relation:

$$\begin{matrix}\hat{s} ( t ) = {s}_{1}^{′} ( t + c ) + {s}_{2}^{′} ( t - {k}_{1}^{′} T + c ) + {s}_{3}^{′} ( t - {k}_{1}^{′} T + {k}_{2}^{′} T + c ) + … + \\ {s}_{i}^{′} ( t + {\sum }_{j = 1}^{i} {( - 1 )}^{j} {k}_{j}^{′} + T + c )\end{matrix}$$

Each integer kj′ is defined as the largest integer such that kj′T≦Lⱼ−(bⱼ−mⱼ), where Lⱼ corresponds to the width of the window of the j^{th} musical passage to be concatenated.

It is indicated that the first bar times, or else the metric, or else the tempo of a piece of music, may be detected automatically, for example by using existing software applications. For example, the MPEG-7 standard (Audio Version 2) provides for the determination and the description of the tempo and of the metric of a piece of music, by using such software applications.

Of course, the present invention is not limited to the embodiment described hereinabove by way of example; it extends to other variants.

Thus, it will be understood that the sound resume may comprise more than two musical passages, for example an introduction, a verse and a refrain, or else two different passages of a verse and of a refrain, such as the introduction and a refrain, for example.

It will also be noted that the steps represented in flowchart form in FIG. 5 may be implemented by computer software whose algorithm globally recalls the structure of the flowchart. In this regard, the present invention is also aimed at such a computer program.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. A method of processing a sound sequence corresponding in particular to a piece of music comprising a succession of subsequences from among at least an introduction, a verse, a refrain, a bridgeway, a theme, a motif, a movement, in which:
a) a spectral transform is applied to said sequence to obtain spectral coefficients varying as a function of time in said sequence,
b) at least one subsequence repeated in said sequence is determined by statistical analysis of said spectral coefficients, and
c) start and end instants of a first subsequence, such as a verse, and of a second subsequence, such as a refrain, are evaluated so as to substantially concatenate the first subsequence with the second subsequence.

14. The method of claim 13 further comprising:
d) of extraction of a repeated subsequence so as to store, in a memory, sound samples representing said subsequence.

15. The method of claim 14, wherein the extraction of d) relates to at least one subsequence whose duration is the biggest and/or one subsequence whose frequency of repetition is the biggest in said sequence.

16. The method of claim 15 wherein the first and the second subsequence are extracted so as to obtain, on a memory medium, a sound resume of said piece of music comprising at least the first subsequence strung together with the second subsequence.

17. The method of claim 16 wherein the extracts of the subsequences are non-contiguous in time, wherein d) includes:
d1) detecting at least one cadence of the first subsequence and/or of the second subsequence so as to estimate the mean duration of a bar at said cadence, as well as at least one end segment of the first subsequence and at least one start segment of the second subsequence, of respective durations corresponding substantially to said mean duration and isolated in the sequence by an integer number of mean durations,
d2) generating at least one transition bar of duration corresponding to said mean duration and comprising an addition of the sound samples of at least said end segment and of at least said start segment,
d3) and concatenating the first subsequence, the transition bar or bars and the second subsequence to obtain a stringing together of the first and of the second subsequence.

18. The method of claim 17 wherein d1) includes a splitting into at least two windows, of rectangular type, of Hanning type, of staircase Hanning type, or preferably of type comprising a flank that rises, a plateau and a flank that descends over time.

19. The method of claim 17 wherein d2) includes a beat-synchronous reconstruction.

20. The method of claim 19 wherein, in d1), the metric of the first subsequence and/or of the second subsequence are/is determined, wherein d2) includes an in-time beat-synchronous reconstruction.

21. The method of claim 19 wherein, in d1), the end and start segments are determined in such a way that they commence with a first bar time, wherein d2) includes an aligned beat-synchronous reconstruction.

22. A computer program product residing on a computer readable medium having a plurality of instructions stored thereon which, when executed by the processor, cause that processor to perform the method of claim 13.
